(19) United States
(12) Patent Application Publication
(10) Pub. No.: US 2025/0105472 A1
(43) Pub. Date: Mar. 27, 2025

(54) INSULATING COATING FOR IMPROVING LITHIUM-ION BATTERY QUALITY

(71) Applicant: GM Global Technology Operations LLC, Detroit, MI (US)

(72) Inventors: Xingcheng Xiao, Troy, MI (US); Kyungjae Lee, Rochester Hills, MI (US); Fang Dai, Troy, MI (US)

(21) Appl. No.: 18/473,216

(22) Filed: Sep. 23, 2023

(51) Int. Cl. H01M 50/534; H01M 4/04; H01M 4/139; H01M 4/62; H01M 10/0525; H01M 50/204

(52) U.S. Cl. CPC H01M 50/534; H01M 4/0402; H01M 4/139; H01M 4/628; H01M 10/0525; H01M 50/204

(57) ABSTRACT

A lithium-ion battery includes a plurality of cells. Each cell comprises an anode, a cathode and a separator that is disposed between the anode and cathode. The anode includes an anode active layer that contacts a current collector. The cathode includes a cathode active layer that contacts the current collector. The current collector from each cell contacts a tab that lies outside the cell. An electrically insulating coating is disposed on a portion of the tab or is disposed on an outer edge of each anode or cathode. The anode and cathode are of different lengths.

### INTRODUCTION

The subject disclosure relates to insulating coatings for improving lithium-ion battery quality.

Lithium-ion batteries have traditionally been used in a variety of small-sized commercial applications such as tablet and laptop computers, cell phones, and the like. More recently, lithium-ion batteries that display high reversible charge capacities of greater than 200 milliampere-hours per gram mass (mAh/g) have been developed. This makes them useful in a variety of high power applications such as in automobiles.

While lithium-ion batteries display the advantageous features described above, they suffer from some drawbacks. These are enumerated below.

The surfaces of the electrode often show that delamination occurs between the electrode (the anode or cathode) active layer and the respective electrode current collector. This delamination sometimes causes active materials from the electrode to contaminate the electrolyte in the battery. It also sometimes leads to shorting, which in turn can causes the temperature of the battery to increase to uncomfortably high values. Unmachined burrs or protrusions along the surfaces of the electrode may potentially cause damage to the separator during electrode stacking. These burrs and protrusions adversely affect cell performance as well. Occasionally, there is cracking or breakage between the electrode and the current collector.

It is therefore desirable to design lithium-ion batteries where some of these defects are avoided or where the undesirable effects of these defects are ameliorated.

### SUMMARY

A lithium-ion battery includes a plurality of cells; where each cell comprises an anode, a cathode and a separator that is disposed between the anode and the cathode. The anode includes an anode active layer that contacts an anode current collector, where the anode current collector from each cell contacts an anode tab that lies outside the cell. The cathode comprises a cathode active layer that contacts a cathode current collector, where the cathode current collector from each cell contacts a cathode tab that lies outside the cell. An electrically insulating coating is disposed on a portion of the anode tab that is in contact with the anode active layer or is disposed on a portion of the cathode tab that is in contact with the cathode active layer or is disposed on an outer edge of each anode and cathode. The anode and cathode are of different lengths.

In an embodiment, the electrically insulating coating is disposed on the portion of the anode tab that contacts the anode current collector or on the portion of the cathode tab that contacts the cathode current collector; where the anode tab contacts the anode current collector at an outer edge of the anode and where the cathode tab contacts the cathode current collector at an outer edge of the cathode.

In another embodiment, the electrically insulating coating is a crosslinked coating.

In yet another embodiment, the crosslinked coating is derived from the polymerization and crosslinking of a repeat unit that comprises an epoxy, an acrylic, an acrylate, a phenolic, a siloxane, a urethane, or a combination thereof.

In yet another embodiment, the crosslinked coating disposed on the anode tab or on the cathode tab is derived from the polymerization and crosslinking of a repeat unit that comprises an epoxy.

In yet another embodiment, the crosslinked coating disposed on the outer edge of each anode or cathode is derived from the polymerization and crosslinking of a repeat unit that comprises an acrylic, an acrylate, a phenolic, a siloxane, a urethane, or a combination thereof.

In yet another embodiment, the electrically insulating coating is crosslinked via ultraviolet radiation, thermal energy, or a combination thereof.

In yet another embodiment, the electrically insulating coating further penetrates into the anode active layer or the cathode active layer and prevents leaching of the active material from the respective active layer.

In yet another embodiment, the electrically insulating coating contacts the anode current collector forming a seal between the anode current collector and the anode active layer.

In yet another embodiment, the electrically insulating coating contacts the cathode current collector forming a seal between the cathode current collector and the cathode active layer.

In yet another embodiment, the electrically insulating coating prevents delamination of active material particles and conductive material particles from the anode active layer and the cathode active layer.

In yet another embodiment, the epoxy is a bisphenol A diglycidyl ether or a cycloaliphatic epoxy.

A method of reducing damage to a lithium-ion battery that comprises a plurality of cells includes disposing a curable composition on an outer edge of an anode or a cathode of at least one cell of the plurality of cells. The curable composition comprises a photoinitiator and a repeat unit of an epoxy, an acrylic, an acrylate, a phenolic, a siloxane, a urethane, or a combination thereof. The curable composition is cured by subjecting it to electromagnetic radiation, thermal energy, or a combination thereof. Each cell comprises an anode, a cathode and a separator disposed between the anode and the cathode. The anode comprises an anode active layer that contacts an anode current collector. The cathode comprises a cathode active layer that contacts a cathode current collector. The anode current collector from each cell contacts an anode tab that lies outside each cell and the cathode current collector contacts a cathode tab that lies outside each cell.

In an embodiment, the curing the curable composition forms an electrically insulating coating on the outer edge at least one cell of the plurality of cells.

In another embodiment, the curable composition is disposed on a portion of the anode tab at a point of contact with the anode current collector or on a portion of the cathode tab at a point of contact with the cathode current collector and where the curable composition is cured to form an electrically insulating coating.

In yet another embodiment, the curable composition is disposed on an outer edge of the anode and the cathode of each cell of the plurality of cells.

In yet another embodiment, the electrically insulating coating further penetrates into the anode active layer or the cathode active layer and prevents leaching of the active material from the active layer.

In yet another embodiment, the electrically insulating coating contacts the anode current collector forming a seal between the anode current collector and the anode active layer.

In yet another embodiment, the electrically insulating coating contacts the cathode current collector forming a seal between the cathode current collector and the cathode active layer.

In yet another embodiment, the electromagnetic radiation is applied in a primary process and a secondary process; where the secondary process follows the primary process; and where the electromagnetic radiation applied in the primary process is ultraviolet radiation.

In yet another embodiment, the electromagnetic radiation applied in the secondary process is different from the electromagnetic radiation applied in the primary process.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIGS. 1A and 1B are a schematic depictions of an exemplary lithium-ion battery that contains a plurality of cells;

FIG. 2A depicts a section of a cell from FIGS. 1A and 1B at an upper edge of the cell before and after the application of the insulating coating;

FIG. 2B depicts a section of a cell from FIGS. 1A and 1B at an upper edge of the cell before and after the application of the insulating coating; and

FIG. 3. is a side view of the outside of the lithium-ion battery taken along section BB′ from FIGS. 1A and 1B and taken in the direction of arrow AA′ before and after the application of the insulating coating on the outer edge of each electrode and on a portion of the tab of each cell.

### DETAILED DESCRIPTION

The following description is merely exemplary in nature and is not intended to limit the present disclosure, its application or uses. In accordance with an exemplary embodiment, a fast curing electrically insulating polymer coating (hereinafter the “insulating coating”) is disposed on a surface of the electrodes of lithium-ion batteries to improve the localized mechanical strength and prevent delamination of active material particles and carbon black from the active layer of the electrodes. This delamination typically causes contamination of the electrolyte during cell assembly. This electrically insulating coating is a crosslinked coating and is applied to the area where the tab contacts the current collector for each cell. It may also be applied to the outer edges of each electrode (the current collector and the respective active layer). This prevents the formation of short circuits when the lithium-ion battery is deformed during assembly or when it is incorporated into another device such as, for example, an automobile. The electrically insulating coating may be applied locally via a spray nozzle (often referred to as nozzle spray) or through printing, followed by focusing UV light on the applied coating to facilitate rapid curing. The rapid-curing process via ultraviolet light can be integrated into the electrode fabrication process or cell assembly process thereby not producing any significant perturbations in the manufacturing process.

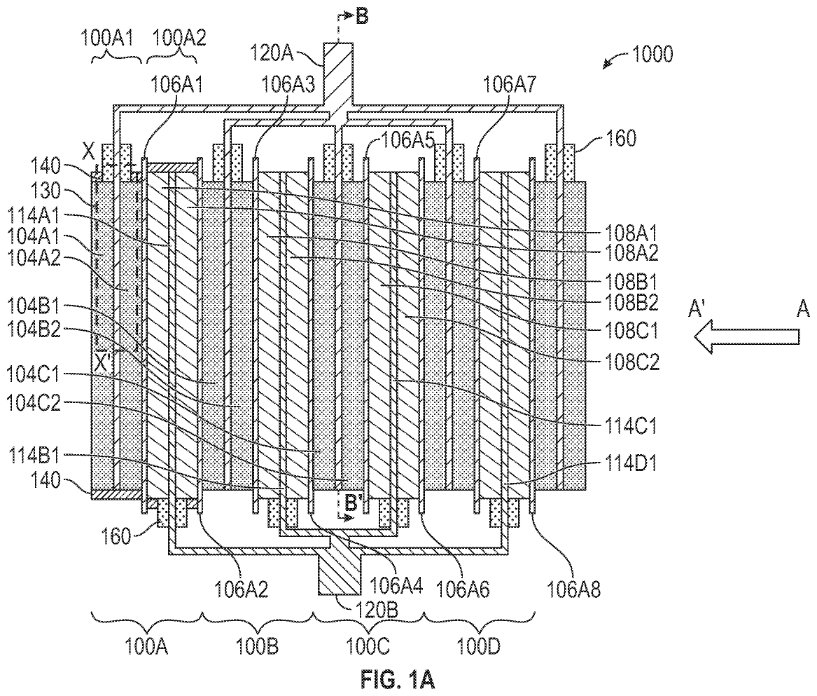

FIGS. 1A and 1B are schematic exemplary cross-sectional depictions of a lithium-ion battery 1000 that comprises 4 cells 100A, 100B, 100C and 100D that has a layer of the insulating polymer 140 (the insulating coating 140) disposed around the outer edges of each of the electrodes. FIGS. 1A and 1B are the same figures. Two figures have been chosen to represent the lithium-ion battery because of the large number of numerals and in order to provide clarity to the reader. The features of each cell of the battery 1000 will be described primarily with respect to cell 100A. Other features of the battery will be detailed as needed in order to convey the appropriate amount of detail to a reader.

While the lithium-ion battery 1000 of the FIGS. 1A and 1B comprises only 4 cells, it can in reality comprise a large plurality of cells. For example, the lithium ion battery can comprise “n” cells, where n is an integer of 1 to 100.

In the FIGS. 1A and 1B, each cell 100A, 100B, 100C and 100D comprises a cathode current collector, a cathode active layer, a separator, an anode active layer and an anode current layer. The anode and the cathode in each cell are separated by a separator. Similarly, each cell is separated from its neighboring cell by a separator. Cell 100A comprises a cathode 100A1 and an anode 100A2 separated by a separator 106A1. In the FIGS. 1A and 1B, the separators having a coefficient of “A” as an odd number are used to separate the cathodes from the anodes (e.g., 106A1, 106A3, where the coefficient of A is 1, 3, and so on), while separators where the coefficient of A is an even number (e.g., 106A2, 106A4, where the coefficient of A is an even number) are used to separate one cell from another. The cathodes (100A1, 100B1, 100C1, and so on) and anodes (100A2, 100B2, 100C2, and so on) of each cell are therefore separated by separators 106A1, 106A3, 106A5, 106A7, and so on, while each cell 100A, 100B, 100C, 100D, and so on are separated from each other by separators 106A2, 106A4, 106A6, 106A8 and so on.

The separators (106A1, 106A3, 106A5, 106A7, and so on) that separate the anodes from the cathodes and those (106A2, 106A4, 106A6, 106A8 and so on) that separate the cells from each other are larger in size than the anodes and cathodes. This may be seen in the FIG. 1A, where the respective separators protrude beyond the boundaries of the anodes and cathodes. The larger size of the separators prevents shorting between the anodes and cathodes. The separator generally comprises a porous electrically insulating polymer.

Cell 100A will now be described in detail. The description of cell 100A can be applied to cells 100B, 100C, 100D, and so on. Cell 100A comprises a cathode 100A1 and an anode 100A2. Cathode 100A1 comprises two cathode active layers 104A1 and 104A2 that are disposed on opposing sides of cathode current collector 112A1. The current collector 112A1, 112B1, 112C1, 112D1 and 112E1 (for each cathode) extend outside of the cathode and are welded to form a cathode tap 120A. The portions of each current collector that protrude beyond the respective electrodes are called tabs and are designated as 112A2, 112B2, 112C2, 112D2, 112E2, and so on. In other words, the portion of cathode current collector 112A1 that extends beyond the active layers 104A1 and 104A2 is called a tab (and denoted as 112A2). The respective tabs extend further away from the active layers and are welded to form a tap, which is typically in electrical communication with a load. The same nomenclature applies to each of the other cathode current collectors in the lithium-ion battery.

The anode 100A2 comprises two anode active layers 108A1 and 108A2 that are disposed on opposing sides of the anode current collector 114A1. The current collectors 114A1, 114B1, 114C1 and 114D1 (for each anode) protrude (beyond the respective anode active layers) to form tabs 114A2, 114B2, 114C2 and 114D2, which are welded together to form an anode tap 120B. As noted above, separator 106A1 separates the cathode 100A1 from anode 100A2. In an embodiment, the anode current collectors and tabs comprise copper, while the cathode current collectors and tabs comprise aluminum.

In an embodiment, the anode and the cathode have differing lengths from each other. The length of a cell may be measured from the upper edge to the lower edge as depicted in FIG. 1A. The anode may be longer than the cathode or vice versa. In the embodiment depicted in FIG. 1A, the cathode for each cell is slightly smaller in length than the anode. The use of different electrode sizes prevents lithium plating at the edge of the anode. Having the cathode and anode be of different lengths, prevents accidental contact between the cathode current collector and the anode active layers or vice versa, thereby mitigating the effects of an accidental thermal runaway. The use of the insulating coating 140 on the cathode tab area prevents direct contact of the anode electrode (the anode active layers) with the cathode current collector even if a problem (such as a rupture) occurs in the separator. Thus, by having anodes and cathodes of different lengths and by using the insulating coating on the edges of the respective cells, thermal runaway can be mitigated.

Each electrode has an insulating coating 140 disposed on its outer edge. The insulating coating 140 extends around the periphery of the entire electrode. This prevents delamination and/or electrical shorting. While the insulating coating is shown only as being disposed on the outer periphery of each electrode (100A1 and 100A2) of the cell 100A in the FIG. 1A, it can be applied to the outer periphery of each of the electrodes of the other cells 100B, 100C, 100D, and so on in the battery 1000. In addition, a portion of each tab that protrudes from each electrode (the cathode or the anode) is coated with the insulating coating 160. The insulating coating can be applied to portions of the tab (outside the electrode) at the point where the tab enters the electrode to function as a current collector for each electrode. Some of these features and points of application of the insulating polymer will be discussed in detail below. The insulating coating 140 and 160 can each have the same chemical composition or can each have a different composition. In an embodiment the insulating coating 140 has a different chemical composition from the insulating coating 160.

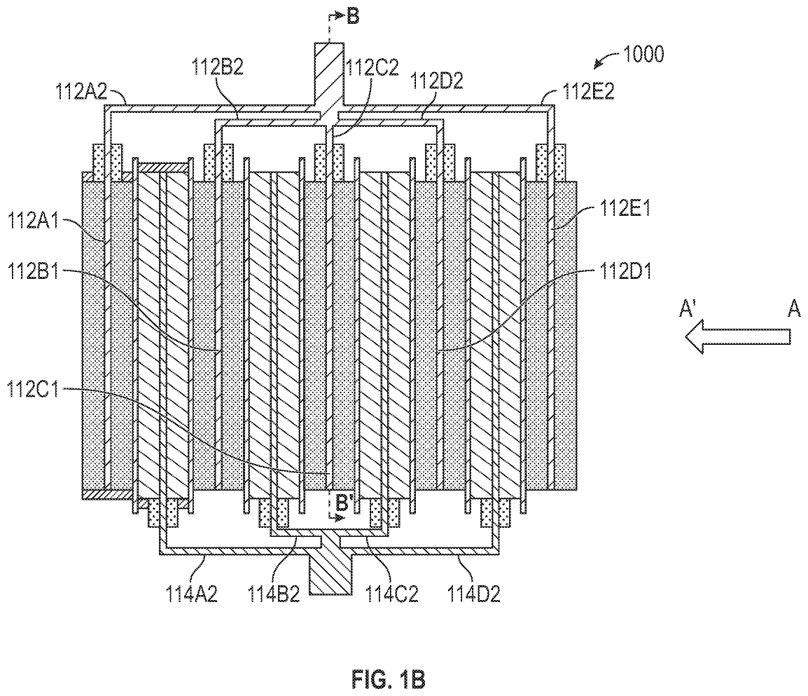

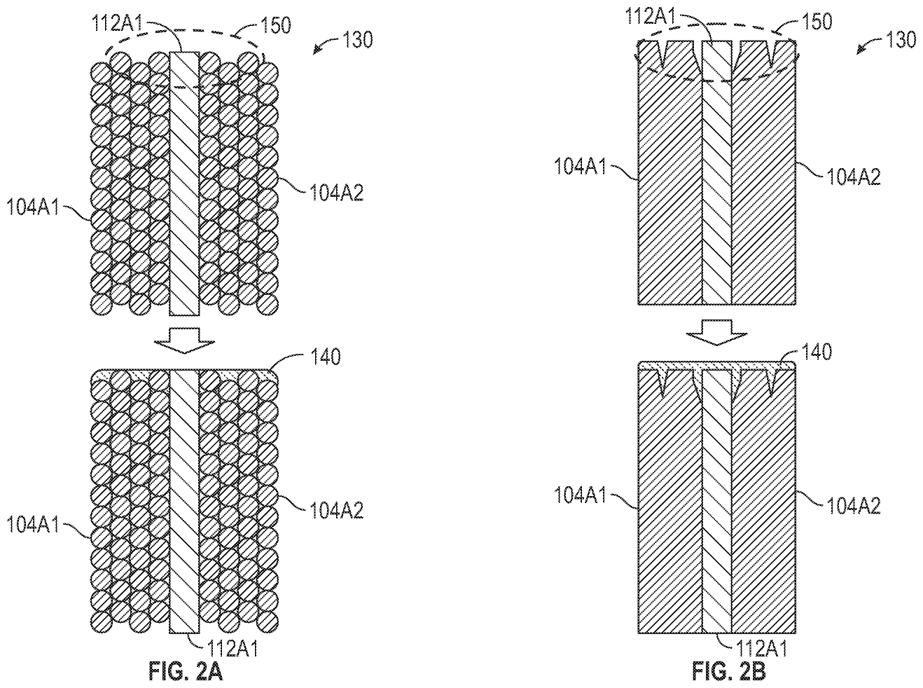

For purposes of depicting the advantages of the application of the insulating coating, a section XX′ (encompassed by a dotted line and represented by the numeral 130) of the FIG. 1A has been chosen for elaboration. Section XX comprises two electrode active layers (in this case cathode active layers 104A1 and 104A2) disposed on opposing surfaces of the cathode current collector 112A1. FIGS. 2A and 2B represent an expanded granular view of the section XX′ of the lithium-ion battery of the FIG. 1A. Both FIGS. 2A and 2B depict the section XX′ at its upper edge 150 before and after the application of the insulating coating 140. The insulating coating 140 penetrates slightly into the active layer (the anode or cathode active layer as the case may be) contacting the active materials and electrically conducting particles (present in the active layer) and seals the edge of the cell. It also contacts the current collector 112A1 forming a seal between the current collector 112A1 and the active layers (104A1 and 104A2) that prevents active materials from leaching out of the active layer and out of the cell.

Prior to the application of the insulating coating, exposure of the outer edge to environmental forces and to various abrasive and deforming forces that occur during manufacturing lead to the leaching of active material particles and other electrically conducting particles from the respective active layers into the electrolyte as well to the exterior of the cell. This leaching of active material particles and electrically conducting particles can lead to short circuiting, which in turn can lead to undesirable elevated temperatures in the lithium-ion battery.

After the application of the insulating coating 140 to the outer edge of the electrode and its curing, the hitherto loose active material particles and electrically conducting particles are held in their positions by the binding forces generated by the insulating coating 140. These binding forces prevent leaching of the active particles and/or other conducting particles thus minimizing the short circuiting and other problems that have been hitherto described.

The application of the insulating coating 140 improves local mechanical strength and reduces or prevents delamination of active material particles and conductive material particles thereby reducing contamination during assembly. It also heals micro-cracks and prevents them from expanding into larger cracks that eventually lead to interfacial delamination especially when exposed to a slicing process. It is to be noted that the insulating coating may be applied along the entire outer edge of the electrodes of the lithium-ion battery as depicted in the FIG. 1A or alternatively may be applied in a puddled form only at regions where the current collector contacts the active layers and where there is an increased possibility of delamination.

As noted above, the insulating coating 160 may be applied to protect the cathode tabs 112A2, 112B2, 112C2, 112D2, 112E2 and so on, or the anode tabs 114A2, 114B2, 114C2, 114D2 and so on (See FIGS. 1A and 1B), from inadvertently contacting each other or from contacting other portions of the cell (such as the opposite cathode or anode active layers) to produce an electrical short. This insulating coating 160 may be applied to a portion of the cathode tabs 112A2, 112B2, 112C2, 112D2, 112E2 (that protrude outside the cathode) and so on, to a portion of the anode tabs 114A2, 114B2, 114C2, 114D2 and so on (that protrude outside the anode), or to both the cathode tabs and the anode tabs (that protrude outside the cathode and the anode respectively). The application of the insulating coating 160 to a portion of each of the tabs mitigates the possibility of an accidental short. The insulating coating is not applied to the taps 120A and 120B because metal to metal contact is desirable for them to be welded to each other.

With reference to FIGS. 1A and 1B, the insulating coating 160 is applied only to a lower portion of the cathode tabs 112A2, 112B2, 112C2, 112D2, 112E2 (that protrude outside the cathode) and so on, or to a lower portion of the anode tabs 114A2, 114B2, 114C2, 114D2 and so on (that protrude outside the anode), that are proximate to the respective current collectors (anode current collectors—112A1, 112B1, 112C1, 112D1, 112E1, and so on) (cathode current collectors—114A1, 114B1, 114C1, 114D1 and so on). The insulating coating 160 is generally applied to the cathode tabs and the anode tabs at the point that the respective current collectors no longer contacts the respective active layer. The upper portion of each of the tabs (cathode tabs 112A2, 112B2, 112C2, 112D2, 112E2, and so on, or anode tabs 114A2, 114B2, 114C2, 114D2, and so on) are not covered with the insulating coating 160 nor are the taps 120A and 120B. This is to facilitate welding of the respective tabs to form the respective taps. The lack of an insulating coating 160 on the respective taps 120A and 120B also permits electrical communication with a load. The insulating coating 160 is applied in a thickness sufficient to prevent the migration of stray currents from a tab to its neighboring tabs.

In an embodiment, the thickness of the insulating coating 140 or 160 may be 200 nanometers to 50 micrometers. The electrically insulating and thermally stable coating applied to the tabs and to the edge of the electrodes serves as a protective barrier preventing short circuits resulting from separator failure, electrode misalignment, and overheating due to high currents.

The material used in the electrically insulating coating and the method of applying the coating will now be described in detail. The materials used in the insulating coatings are polymeric in nature. They are typically photosensitive polymer precursors that can be cured using electromagnetic radiation to form irreversible polymeric networks. Ultraviolet radiation is used to cure these photosensitive polymer precursors. Increased temperature may also be used to initiate or the facilitate crosslinking. They are therefore capable of handling high temperatures and potentially corrosive salts and electrolytes without undergoing any chemical degradation. Examples of photosensitive polymer precursors are epoxies, acrylics and acrylates, phenolics, silicone resins, polyurethane resins, or a combination thereof. In other words, the insulating coating is derived from the polymerization and crosslinking of repeat units that comprise an epoxy, an acrylic, an acrylate, a phenolic, a siloxane, a urethane, or a combination thereof. In an embodiment, the insulating coating 140 is has a different chemical composition from the insulating coating 160.

Examples of epoxies are bisphenol A diglycidyl ether (BADGE) or a cycloaliphatic epoxy. The epoxies are typically combined with a photoinitiator to undergo a reaction when exposed to ultraviolet radiation. Epoxies are used to form the insulating coating 160 that is disposed on the tabs.

Examples of acrylics and acrylates are methyl methacrylate (MMA), ethyl methacrylate (EMA), butyl acrylate (BA), acrylic acid, or a combination thereof. Examples of phenolics are phenol-formaldehyde resins. Examples of silicone polymers are vinyl terminated polysiloxanes, while examples of polyurethanes are isocyanate-terminated prepolymers combined with hydroxyl-functional monomers and a photoinitiator. The acrylics, acrylates, phenolics, silicone polymer and polyurethanes are generally used as the insulating coating 140 on the edges of the electrode in lithium-ion batteries. Suitable initiators for crosslinking may be used with each of the different repeat units detailed above.

In one embodiment, a curing composition comprising one of the foregoing polymer precursors is mixed with the appropriate amount of initiator(s), optional crosslinking agents, optional solvents and other additives to form a reactive solution. The reactive solution is applied via a spray nozzle, via brushing or via printing to form a layer of the precursor composition on the outer edges of each electrode in each cell of the lithium-ion battery as detailed in the cell 100A of the FIG. 1A. In an embodiment, the precursor composition is applied on one or more outer edges of the electrode. It is generally applied to any electrode edge that would normally contact an ambient atmosphere in the absence of the insulating coating 140.

The precursor composition is optionally not applied on the outer edges of the separator, which typically tends to be larger in surface area than a surface of the electrodes. The precursor composition is then subjected to curing via radiation and optional thermal treatment. The radiation may be applied in one or two stages (e.g., a primary process and/or a secondary process). The radiation includes ultraviolet curing, x-ray curing, electron beam curing, microwave curing, or combination thereof. In an exemplary embodiment, the radiation in the primary process includes ultraviolet curing.

In an embodiment, the precursor coating may be subjected to an optional secondary process to facilitate further curing. The secondary process may include thermal annealing at an elevated temperature and or irradiation by a second form of electromagnetic radiation that is the same or different from the electromagnetic radiation used in primary process. For example, if the primary curing process involves the use of ultraviolet radiation, the secondary curing process may optionally include thermal annealing at an elevated temperature followed by optional curing using either additional ultraviolet radiation or electron beam radiation.

The annealing at elevated temperature is conducted to remove any residual solvent from the insulating coating and to facilitate additional curing. Annealing may be conducted at elevated temperatures that are dependent upon the polymer precursor used. Typical annealing temperatures are 50 to 200° C. for a time period of 5 to 240 minutes.

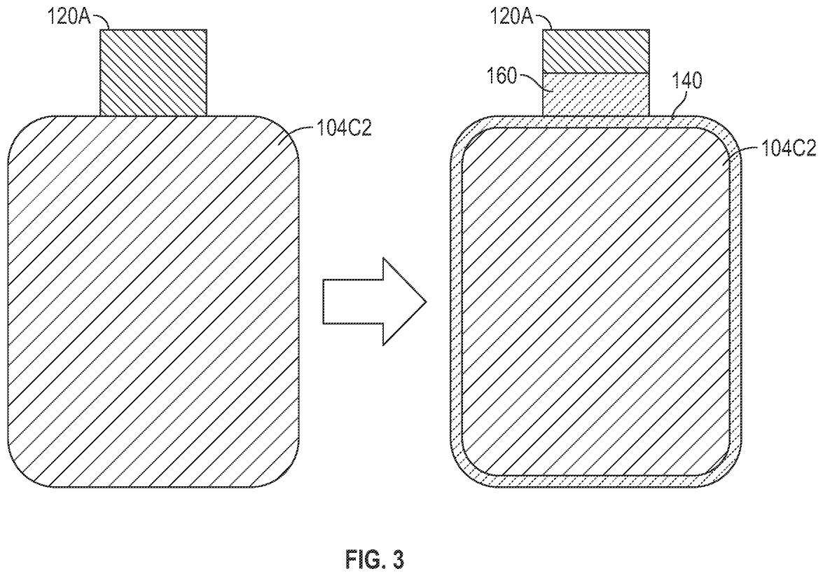

FIG. 3 is an exemplary depiction of a side view of a section at BB′ (as viewed in the direction of the arrow AA′ from the FIG. 1A) of the lithium-ion battery 1000 before and after the application of the insulating coating 160 to the cathode tabs 112A2, 112B2, 112C2, and so on or the anode tabs 114A2, 114B2, 114C2, and so on (See FIG. 1B). From the FIG. 3 it may be seen that before the application of the insulating coating layer (see left hand side of arrow in the FIG. 3), only the tap 120A and the cathode active layer 104C2 are visible. After the application of the insulation coating 160 to the cells of the lithium-ion battery followed by curing and drying, the insulation coating 160 is also visible on only the lower portion of the tab 112C1 (which protrudes further upwards to become a part of tap 120A). This may be seen on the right side of the arrow (facing the viewer along the direction of arrow AA′) in the FIG. 3. The side view in the FIG. 3 on the right side of the arrow also shows the insulating coating 140 that is disposed on an outer edge of the electrode (on all sides) to prevent delamination.

The materials used in the anode and cathode current collectors, the anode active layers, the cathode active layers, and the separator will now be discussed in detail. The anode and cathode current collectors, tabs and taps generally comprise metals. In an embodiment, the anode current collector comprises stainless steel, copper, nickel, iron, titanium, or a combination thereof, while the cathode current collector comprises stainless steel, aluminum, nickel, iron, titanium, or a combination thereof.

The anode active layers 108A1, 108A2, 108B1, 108B2, 108C1, 108C2, and so on, and the cathode active layers 104A1, 104A2, 104B1, 104B2, 104C1, 104C1 and so on in the lithium-ion battery depicted in FIG. 1A each comprises an active material (the anode active layer comprises an anode active material, while the cathode active layer comprises a cathode active material), an electrically conducting additive and a binder. Each of these are described below.

Anode active materials include some of the aforementioned carbonaceous materials, hard carbon, silicon, silicon mixed with graphite, silicon oxide mixed with graphite, carbon encapsulated silicon particles, Li₄Ti₅O₁₂; transition metals such as, for example, tin, metal oxides, metal sulfides, (e.g., TiO₂, FeS, and the like) lithium metal and alloys, or a combination thereof. Exemplary active materials may include graphite, hard carbon, activated carbon, nanoform carbon, silicon, silicon oxides, silicon oxide mixed with graphite, carbon encapsulated silicon nanoparticles, or a combination thereof. In some such embodiments, the anode active material may be intercalated with lithium (e.g., using pre-lithiation methods known in the art).

Hard carbon is a solid form of carbon that cannot be converted to graphite by heat-treatment, even at temperatures as high as 3000° C. It is also known as char, or non-graphitizing carbon. Hard carbon is produced by heating carbonaceous precursors to approximately 1000° C. in the absence of oxygen. Among the precursors for hard carbon are polyvinylidene chloride (PVDC), lignin and sucrose. Other precursors, such as polyvinyl chloride (PVC) and petroleum coke, produce soft carbon, or graphitizing carbon. Soft carbon can be readily converted to graphite by heating to 3000° C.

In an exemplary embodiment, the anode active material comprises silicon oxide mixed with graphite. The anode active material may be used in the anode active layer respectively in an amount of 3 to 99 wt %, based on a total weight of the anode active layer. In an embodiment, anode active material may be used in the anode active layer respectively in an amount of 4 to 60 wt %, based on a total weight of the anode active layer.

Cathode active materials may include lithium cobalt oxide (LCO, sometimes called “lithium cobaltate” or “lithium cobaltite”—one variant of which is LiCoO₂); lithium nickel manganese cobalt oxide (NMC, with a variant formula of LiNiMnCo); lithium manganese oxide (LMO with variant formulas of LiMn₂O₄, Li₂MnO₃ and others); lithium nickel cobalt aluminum oxide (LiNiCoAlO₂ and variants thereof as NCA) and lithium titanate oxide (LTO, with one variant formula being LLi₄Ti₅O₁₂); lithium iron phosphate oxide (LFP, with one variant formula being LiFePO₄), lithium nickel cobalt aluminum oxide (and variants thereof as NCA) as well as other similar other materials, spinel (LiMn₂O₄, LiNi_{0.5}Mn_{1.5}O₄), polyanion cathode (LiV₂(PO₄)₃), and other lithium transition-metal oxides. Surface-coated and/or doped cathode materials mentioned above. e.g., LiNbO₃-coated LiMn₂O₄ and Al-doped LiMn₂O₄, may also be used. Low voltage cathode materials, e.g., lithiated metal oxide/sulfide (e.g., LiTiS₂), lithium sulfide and sulfur, may also be used.

Other variants of the foregoing may be included. In some embodiments where NMC is used as an active material, nickel rich NMC may be used. For example, in some embodiments, the variant of NMC may be LiNiₓMn_{y}Co_{(1-x-y)}O₂, LiNiₓMn_{y}Al_{(1-x-y)}O₂, LiNiₓMn₍₁₋ₓ₎O₂, Li₍₁₊ₓ₎MO₂, where x is equal to or greater than about 0.7, 0.75, 0.80, 0.85, or more and where y is less than 0.15. In an embodiment, y is less than 0.1. In some embodiments, NMC811 may be used, where in the foregoing formula x is about 0.8 and y is about 0.1.

The cathode active material may be used in the cathode active layers 108A, 108B and 108C respectively in an amount of 50 to 98 wt %, based on a total weight of each cathode active layer. In an embodiment, the cathode active material is used in the cathode active layer in an amount of 70 to 95 wt %, based on a total weight of each cathode active layer.

The anode active layers 108A1, 108A2, 108B1, 108B2, 108C1, 108C2, and so on, and the cathode active layers 104A1, 104A2, 104B1, 104B2, 104C1, 104C1 and so on, may both contain an electrically conducting additive. The electrically conducting additive used in both the anode active material and the cathode active material comprises an electrically conducting carbonaceous material. Examples of electrically conducting carbonaceous materials include carbon nanotubes, carbon black, activated carbon, graphene, graphite, graphite oxide, carbon fibers, or the like, or a combination thereof.

Carbon nanotubes include single wall carbon nanotubes (SWNTs), double wall carbon nanotubes (DWNTs), multiwall carbon nanotubes (MWNTs), or a combination thereof and have diameters of 2 to 100 nanometers, with diameters of 10 to 50 nanometers being desirable. They have lengths of 20 to 10,000 nanometers, with lengths of 200 to 5000 nanometers being desirable. Aspect ratios greater than 10, greater than 50 and greater than 100 are desirable.

Carbon black having a high surface area is preferred for use in the electrode. Carbon black (subtypes are acetylene black, channel black, furnace black, lamp black and thermal black) is a material produced by the incomplete combustion of coal and coal tar, vegetable matter, or petroleum products, including fuel oil, fluid catalytic cracking tar, and ethylene cracking in a limited supply of air. Carbon black is a form of paracrystalline carbon that has a high surface-area-to-volume ratio, albeit lower than that of activated carbon. Carbon black having a surface area of 50 to 1000 m²/gm may be used in the slurry that is used to form the electrode.

Activated carbon also called activated charcoal, is a form of carbon that has a surface area in excess of 3,000 m²/gm as determined by gas adsorption. It can be used in conjunction with other electrically conducting carbonaceous elements listed herewith. Examples of carbon black or activated carbon that can be used in the electrode-forming slurry are Keltjen™ Black or Super P.

Graphene is an allotrope of carbon consisting of a single layer of atoms arranged in a hexagonal lattice nanostructure. Graphene that is added to the slurry may be in the form of individual graphene sheets or in the form of a plurality of loosely connected graphene sheets. Each atom in a graphene sheet is connected to its three nearest neighbors by σ-bonds and a delocalised π-bond, which contributes to a valence band that extends over the whole sheet. This is the same type of bonding seen in carbon nanotubes and polycyclic aromatic hydrocarbons, and in fullerenes and glassy carbon. The valence band is touched by a conduction band, making graphene a semimetal with unusual electronic properties that are best described by theories for massless relativistic particles.

Graphite particles may also be used in the electrically conducting composition. Graphite is a natural manifestation of pure carbon with a hexagonal crystal structure that is arranged in several parallel levels, called graphene layers. In short, graphite particles comprise a plurality of graphene sheets that are arranged to be parallel to each other. This anisotropic structure gives the graphite special properties, such as electrical conductivity or a particular strength along the individual layers. It is extremely heat-resistant with a sublimation point of over 3,800° C., thermally highly conductive and chemically inert.

Graphite oxide (GO), sometimes called graphene oxide, graphitic oxide or graphitic acid, is a compound of carbon, oxygen, and hydrogen in variable ratios, obtained by treating graphite with strong oxidizers and acids for resolving of extra metals. The maximally oxidized bulk product is a yellow solid with a C:O ratio between 2.1:1 and 2.9:1, that retains the layer structure of graphite but with a much larger and irregular spacing. The bulk material spontaneously disperses in basic solutions or can be dispersed by sonication in polar solvents to yield monomolecular sheets, known as graphene oxide by analogy to graphene, the single-layer form of graphite. Graphene oxide sheets exist in the form of strong paper-like materials, membranes, thin films, and composite materials and can be used in the electrode-forming slurry that is used to prepare the electrodes.

Carbon fibers have diameters of 5 to 10 micrometers and are composed mostly of carbon atoms. They can have lengths greater than 1000 micrometers, with lengths greater than 10,000 micrometers being desirable. They are produced by drawing pitch or polyacrylonitrile polymeric fibers under high pressures and temperatures of over 1500° C. to up to 2400°° C. Carbon fibers are different from carbon nanotubes and do not have cylindrical graphene sheets arranged concentrically. The carbon fibers typically comprise high aspect ratio graphene sheets arranged to be in a parallel configuration with each other.

The aforementioned carbon nanotubes, carbon black, activated carbon, graphene sheets, graphite particles, graphite oxide particles, or a combination thereof may be used individually or in any combination to form an electrically conducting network. In an exemplary embodiment, the carbon nanotubes typically are used in the largest amount when compared with the other carbonaceous ingredients.

The anode active layers 108A1, 108A2, 108B1, 108B2, 108C1, 108C2, and so on, and the cathode active layers 104A1, 104A2, 104B1, 104B2, 104C1, 104C1 and so on, may contain the electrically conducting additive in an amount of up to 30 wt %. The electrically conducting additive may be present in an amount of less than 20 wt %, with less than 10 wt % being desirable, based on a total weight of the respective anode or cathode active layer. In an embodiment, the anode or cathode active layer may contain the electrically conducting additive in an amount of 1 wt % or more, based on a total weight of the respective anode or cathode active layer.

The anode and cathode active layers may optionally contain a binder. The polymeric binder generally comprises an organic polymer. Examples of organic polymer include poly (tetrafluoroethylene) (PTFE), styrene ethylene butylene styrene copolymer (SEBS), styrene butadiene styrene copolymer (SBS), acrylonitrile butadiene rubber (NBR), styrene-butadiene rubber (SBR), poly(propylene carbonate) PPC, sodium carboxymethyl cellulose (CMC), poly(vinylidene fluoride) (PVDF), poly(vinylidene fluoride-co-hexafluoropropylene) (PVdF-HFP), polyacrylonitrile (PAN), poly(vinylidene fluoride-co-chlorotrifluoroethylene) (P(VDF-CTFE)), poly(vinylidene fluoride-trifluoroethylene) (P(VDF-TeFE)), poly (vinylidene fluoride-trifluoroethylene-chlorofluoroethylene) terpolymer (P(VDF-TrFE-CFE)), or a combination thereof. In a preferred embodiment, the polymeric binder used in the active layer is poly(vinylidene fluoride-hexafluoropropylene) copolymer. The polymeric binder has a weight average molecular weight of 5,000 to 1,000,000 grams per mole. In an embodiment, the polymeric binder has a weight average molecular weight of 50,000 to 750,000 grams per mole. In another embodiment, the polymeric binder has a weight average molecular weight of 75,000 to 500,000 grams per mole. Weight average molecular weight is measured using gel permeation chromatography with a polystyrene standard.

The polymeric binder is optional and if used in the anode active layer or the cathode active layer, is present in an amount of less than 5 wt %. In an embodiment, it is used in an amount of less than 3 wt %, based on a total weight of the respective anode or cathode active layer. In another embodiment, it is used in an amount of less than 1 wt %, based on a total weight of the respective anode or cathode active layer.

The separators 106A1, 106A2, 106A3, and so on, generally comprise a porous electrically insulating film. Examples of electrically insulating materials that are used as separators are polyolefins (e.g., polyethylene, polypropylene, or a combination thereof), polyimides, polyaramides, polyfluoroethylenes (e.g., polytetrafluoroethylene), polysiloxanes (e.g., polydimethylsiloxane), or a combination thereof.

In the preparation of the anode active layers 108A1, 108A2, 108B1, 108B2, 108C1, 108C2, and so on, and the cathode active layers 104A1, 104A2, 104B1, 104B2, 104C1, 104C1 and so on, the respective anode active material or cathode active material along with the electrically conducting additive and the optional binder may be mixed with a suitable solvent to create an anode active material slurry or a cathode active material slurry. The respective slurry is applied to the appropriate current collector (the anode active material slurry is applied to the anode current collector while the cathode active material slurry is applied to the cathode current collector). The active material slurry is dried to form the active material layer.

With reference again to FIG. 1A, the anode active layers 108A1, 108A2, 108B1, 108B2, 108C1, 108C2, and so on together with the respective current collectors 114A1, 114B1, and so on, forms the anode of the lithium-ion battery. The cathode active layers 104A1, 104A2, 104B1, 104B2, 104C1, 104C1 and so on together with the respective current collectors 112A1, 112B1, 112C1, and so on, form the cathode of the lithium-ion battery. The respective separators (with the odd-numbered coefficient) 106A1, 106A3, 106A5 are disposed between the anode active layers and the cathode active layers as detailed above, while the separators with the even numbered coefficient 106A2, 106A4, 106A6, and so on are disposed between the cells 100A, 100B, 100C and so on to form the lithium ion battery. An electrolyte may be charged to the cells. The tabs 112A2, 112B2, 112C2, and so on are joined together and welded to form tap 120A. The tabs 114A2, 114B2, 114C2, and so on are joined together and welded to form tap 120B.

The layer of insulating polymer 140 is then disposed on the outer edge (of each electrode (the anode or the cathode) in each cell via brushing, printing or spraying (via a nozzle) as described above. With reference now to the FIGS. 1A and 1B it may seen that the insulating layer 140 contacts the outer edge of the electrodes but does not contact the separator.

The insulating coatings are then subjected to curing using radiation (ultraviolet) or thermal energy (heat). The insulating coating 160 may also be applied to the tabs 112A2, 112B2, 112C2, and so on, and/or to the tabs 114A2, 114B2, 114C2, and so on, via brushing, printing or spraying (via a nozzle) as described above.

The disposing of the layer of insulating polymer 140 on the outer edge of the electrodes and the disposing of the insulating coating 160 on the tabs prevents delamination and short circuits in the cells of the lithium-ion battery. It minimizes the leaching of active materials into the electrolyte and increases the life of the lithium-ion battery.

The terms “a” and “an” do not denote a limitation of quantity, but rather denote the presence of at least one of the referenced item. The term “or” means “and/or” unless clearly indicated otherwise by context. Reference throughout the specification to “an aspect,” means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure is not limited to the particular embodiments disclosed, but will include all embodiments falling within the scope thereof.

What is claimed is:

1. A lithium-ion battery comprising:
a plurality of cells; where each cell comprises:
an anode; where the anode comprises an anode active layer that contacts an anode current collector; where the anode current collector from each cell contacts an anode tab that lies outside the cell;
a cathode; where the cathode comprises a cathode active layer that contacts a cathode current collector; where the cathode current collector from each cell contacts a cathode tab that lies outside the cell; where the cathode has a different length from the anode;
a separator; where the separator is disposed between the anode and cathode; and
an electrically insulating coating that is disposed on a portion of the anode tab that is in contact with the anode active layer or is disposed on a portion of the cathode tab that is in contact with the cathode active layer or is disposed on an outer edge of each anode and cathode.

2. The lithium-ion battery of claim 1, where the electrically insulating coating is disposed on the portion of the anode tab that contacts the anode current collector or on the portion of the cathode tab that contacts the cathode current collector; where the anode tab contacts the anode current collector at an outer edge of the anode and where the cathode tab contacts the cathode current collector at an outer edge of the cathode.

3. The lithium-ion battery of claim 2, where the electrically insulating coating is a crosslinked coating.

4. The lithium-ion battery of claim 3, where the crosslinked coating is derived from a polymerization and crosslinking of a repeat unit that comprises an epoxy, an acrylic, an acrylate, a phenolic, a siloxane, a urethane, or a combination thereof.

5. The lithium-ion battery of claim 4, where the crosslinked coating disposed on the anode tab or on the cathode tab is derived from the polymerization and crosslinking of a repeat unit that comprises an epoxy.

6. The lithium-ion battery of claim 4, where the crosslinked coating disposed on the outer edge of each anode or cathode is derived from the polymerization and crosslinking of a repeat unit that comprises an acrylic, an acrylate, a phenolic, a siloxane, a urethane, or a combination thereof.

7. The lithium-ion battery of claim 3, where the electrically insulating coating is crosslinked via ultraviolet radiation, thermal energy, or a combination thereof.

8. The lithium-ion battery of claim 1, where the electrically insulating coating further penetrates into the anode active layer or the cathode active layer and prevents leaching of an active material from the respective active layer.

9. The lithium-ion battery of claim 1, where the electrically insulating coating contacts the anode current collector forming a seal between the anode current collector and the anode active layer.

10. The lithium-ion battery of claim 1, where the electrically insulating coating contacts the cathode current collector forming a seal between the cathode current collector and the cathode active layer.

11. The lithium-ion battery of claim 1, where the electrically insulating coating prevents delamination of active material particles and conductive material particles from the anode active layer and the cathode active layer.

12. The lithium-ion battery of claim 5, where the epoxy is a bisphenol A diglycidyl ether or a cycloaliphatic epoxy.

13. A method of reducing damage to a lithium-ion battery that comprises a plurality of cells, the method comprising:
disposing a curable composition on an outer edge of an anode or a cathode of at least one cell of the plurality of cells; where the curable composition comprises a photoinitiator and a repeat unit of an epoxy, an acrylic, an acrylate, a phenolic, a siloxane, a urethane, or a combination thereof; and
curing the curable composition by subjecting it to electromagnetic radiation, thermal energy, or a combination thereof; where each cell comprises:
an anode; where the anode comprises an anode active layer that contacts an anode current collector;
a cathode; where the cathode comprises a cathode active layer that contacts a cathode current collector; and
a separator; where the separator is disposed between the anode and cathode; where the anode current collector from each cell contacts an anode tab that lies outside each cell and where the cathode current collector contacts a cathode tab that lies outside each cell.

14. The method of claim 13, where the curing the curable composition forms an electrically insulating coating on the outer edge of at least one cell of the plurality of cells.

15. The method of claim 13, further comprising disposing the curable composition on a portion of the anode tab at a point of contact with the anode current collector or on a portion of the cathode tab at a point of contact with the cathode current collector and curing the curable composition to form an electrically insulating coating.

16. The method of claim 15, where the electrically insulating coating further penetrates into the anode active layer or the cathode active layer and prevents leaching of an active material from the respective active layer.

17. The method of claim 15, where the electrically insulating coating contacts the anode current collector forming a seal between the anode current collector and the anode active layer.

18. The method of claim 15, where the electrically insulating coating contacts the cathode current collector forming a seal between the cathode current collector and the cathode active layer.

19. The method of claim 15, where the electromagnetic radiation is applied in a primary process and a secondary process; where the secondary process follows the primary process; and where the electromagnetic radiation applied in the primary process is ultraviolet radiation.

20. The method of claim 19, where the electromagnetic radiation applied in the secondary process is different from the electromagnetic radiation applied in the primary process.
